(19) United States
(12) Patent Application Publication
(10) Pub. No.: US 2013/0021230 A1
(43) Pub. Date: Jan. 24, 2013

(54) Apparatus, Method and Module for Selective Pixel Control of Display

(71) Applicant: Johan L. Bergquist, Tokyo (JP)

(72) Inventor: Johan L. Bergquist, Tokyo (JP)

(73) Assignee: NOKIA CORPORATION, Espoo (FI)

(21) Appl. No.: 13/581,685

(22) PCT Filed: Mar. 1, 2010
(86) PCT No.: PCT/IB2010/050879

§ 371 Date: Sep. 25, 2012

(51) Int. Cl. G09G 3/36

(52) U.S. Cl. 345/90

(57) ABSTRACT

An apparatus including: a pixellated polarizer including a first array of pixels wherein each pixel can be selectively controlled either to provide a defined polarization or not to provide a defined polarization; a pixellated light emitter including a second array of pixels wherein each pixel can be selectively controlled to emit light; a reflector; and a controller configured to control the pixellated polarizer and pixellated light emitter to adopt in a first context a transmissive mode, in a second context a reflective mode and in a third context a selective transflective mode. In the respective transmissive/reflective/selective transflective mode, pixels of the respective pixellated light emitter are selectively controlled to emit light/controlled not to emit light/selectively controlled to emit light and the pixels of the pixellated polarizer are unselectively controlled to provide the defined polarization/controlled to selectively provide the defined polarization/controlled to selectively provide a defined polarization.

### FIELD OF THE INVENTION

Embodiments of the present invention relate to a display apparatus, a method, a module.

### BACKGROUND TO THE INVENTION

A display apparatus typically comprises a plurality of picture elements (pixels) arranged in an array. Selective control of the pixels enables information to be presented visually by the display apparatus.

A display apparatus can be used in different lighting environments and can be used to present different types of content to a user.

### BRIEF DESCRIPTION OF VARIOUS EMBODIMENTS OF THE INVENTION

According to various, but not necessarily all, embodiments of the invention there is provided an apparatus comprising: a pixellated polarizer comprising a first array of pixels wherein each pixel can be selectively controlled either to provide a defined polarization or not to provide a defined polarization; a pixellated light emitter comprising a second array of pixels wherein each pixel can be selectively controlled to emit light; a reflector; and a controller configured to control the pixellated polarizer and pixellated light emitter to adopt in a first context a transmissive mode, in a second context a reflective mode and in a third context a selective transflective mode, wherein
in the transmissive mode, pixels of the pixellated light emitter are selectively controlled to emit light and the pixels of the pixellated polarizer are unselectively controlled to provide the defined polarization;
in the reflective mode pixels of the pixellated light emitter are controlled not to emit light and the pixels of the pixellated polarizer are controlled to selectively provide the defined polarization;
in the selective transflective mode pixels of the pixellated light emitter are selectively controlled to emit light and the pixels of the pixellated polarizer are controlled to selectively provide a controlled polarization

In the transmissive mode, pixels of the pixellated light emitter may be selectively controlled to emit light and the pixels of the pixellated polarizer may be unselectively controlled to provide the defined polarization preventing the output of light reflected off the reflector but enabling the unselective output of light emitted by the selectively controlled pixels of the pixellated light emitter.

In the reflective mode pixels of the pixellated light emitter may be controlled not to emit light and the pixels of the pixellated polarizer may be controlled to selectively provide the defined polarization wherein those pixels of the pixellated polarizer that provide the defined polarization prevent the output of light reflected off the reflector and those pixels of the pixellated polarizer that do not provide the defined polarization enable the output of light reflected off the reflector.

According to various, but not necessarily all, embodiments of the invention there is provided a method comprising: determining whether to control a pixellated polarizer and a pixellated light emitter to adopt a transmissive mode, a reflective mode or a selective transflective mode; in a first context entering the transmissive mode and selectively controlling pixels of the pixellated light emitter to emit light and unselectively controlling pixels of the pixellated polarizer to provide a defined polarization; in a second context entering the reflective mode and controlling pixels of the pixellated light emitter not to emit light and controlling the pixels of the pixellated polarizer to selectively provide the defined polarization; in a third context entering the selective transflective mode and selectively controlling pixels of the pixellated light emitter to emit light and controlling the pixels of the pixellated polarizer to selectively provide a defined polarization.

According to various, but not necessarily all, embodiments of the invention there is provided a module for an apparatus comprising: a pixellated polarizer comprising a first array of pixels wherein each pixel can be selectively controlled either to provide a defined polarization or not to provide a defined polarization; a pixellated light emitter comprising a second array of pixels wherein each pixel can be selectively controlled to emit light; a reflector; and a controller configured to control the pixellated polarizer and pixellated light emitter to adopt in a first context a transmissive mode, in a second context a reflective mode and in a third context a selective transflective mode, wherein
in the transmissive mode, pixels of the pixellated light emitter are selectively controlled to emit light and the pixels of the pixellated polarizer are unselectively controlled to provide the defined polarization;
in the reflective mode pixels of the pixellated light emitter are controlled not to emit light and the pixels of the pixellated polarizer are controlled to selectively provide the defined polarization;
in the selective transflective mode pixels of the pixellated light emitter are selectively controlled to emit light and the pixels of the pixellated polarizer are controlled to selectively provide a defined polarization.

Embodiments provide a display apparatus that can be used in different lighting environments and can be used to present clearly different types of content such as text and colored image to a user.

The high resolution and high contrast required for presenting text may be provided by the pixellated polarizer in the reflective mode or the selective transflective mode, depending on ambient lighting. This can save power and cost.

The color saturation and emissive luminance required for presenting images may be provided by the pixellated light emitter in the transmissive mode.

One portion of a display may have the high resolution and high contrast required for presenting text (provided by the pixellated polarizer in the reflective mode or the selective transflective mode) and another portion of the display may simultaneously have the color saturation and brightness required for presenting images (provided by the pixellated light emitter in the transmissive mode).

### BRIEF DESCRIPTION OF THE DRAWINGS

For a better understanding of various examples of embodiments of the present invention reference will now be made by way of example only to the accompanying drawings in which:

FIG. 1 schematically illustrates a display apparatus;

FIGS. 2A and 2B schematically illustrate a table that characterize display modes and sub-modes of the display apparatus;

FIG. 3A schematically illustrates the operation of a pixellated light emitter when emitting light 31;

FIG. 3B schematically illustrates the operation of the display apparatus with respect to reflected light;

FIG. 4 schematically illustrates another embodiment of a controller;

FIG. 5 schematically illustrates a suitable method for performance by the controller;

FIG. 6 schematically illustrates a suitable method for performance by the controller; and

FIG. 7 schematically illustrates one implantation of the display apparatus.

### DETAILED DESCRIPTION OF VARIOUS EMBODIMENTS OF THE INVENTION

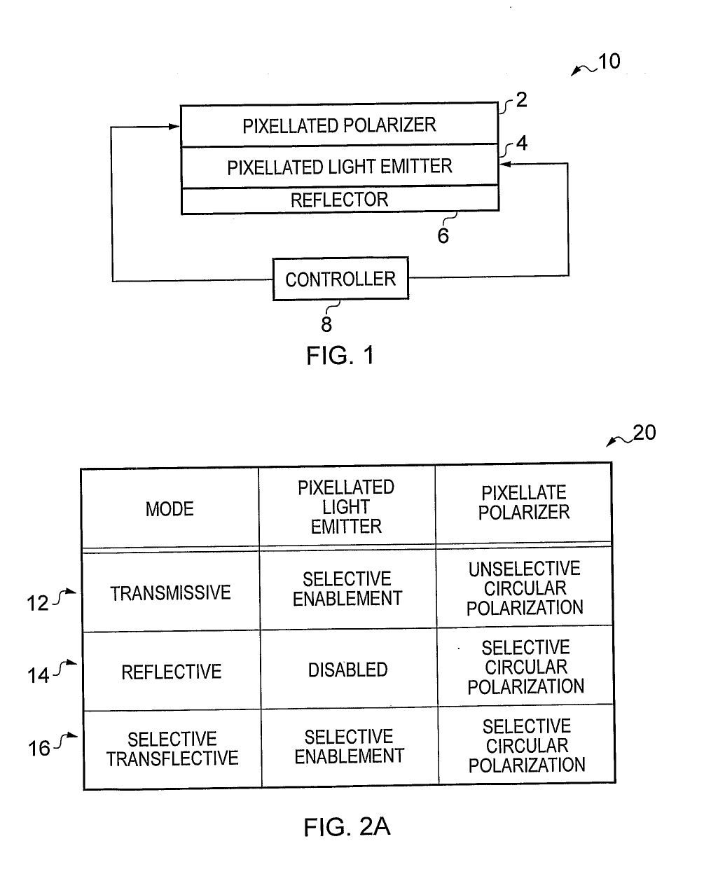

FIG. 1 schematically illustrates a display apparatus 10 comprising: a pixellated polarizer 2 comprising a first array of pixels wherein each pixel can be selectively controlled either to provide a defined polarization or not to provide the defined polarization; a pixellated light emitter 4 comprising a second array of pixels wherein each pixel can be selectively controlled to emit light; a metal reflector 6; and a controller 8 configured to control the pixellated polarizer 2 and pixellated light emitter 4 to adopt in a first context a transmissive mode 12, in a second context a reflective mode 14 and in a third context a selective transflective mode 16.

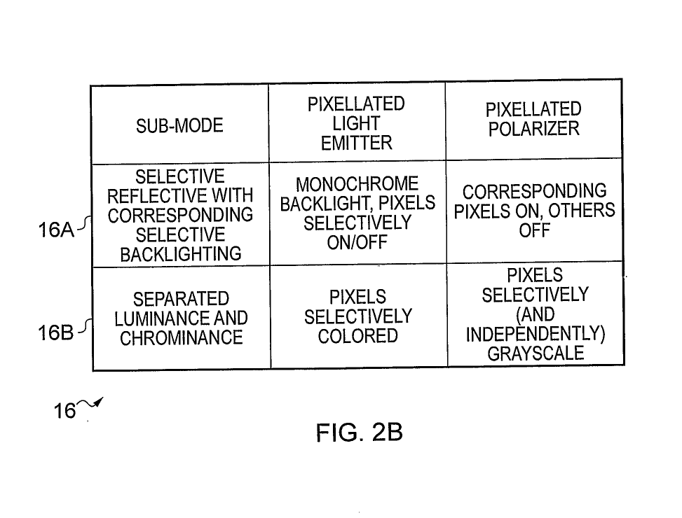

FIG. 2A schematically illustrates a table 20 that identifies the state of the pixellated light emitter 4 and the pixellated polarizer 2 in each of the transmissive mode 12, the reflective mode 14 and the selective transflective mode 16.

In the transmissive mode 12, pixels of the pixellated light emitter 4 are selectively controlled to emit light and the pixels of the pixellated polarizer 2 are unselectively controlled to provide the defined circular polarization preventing the output of light reflected off the reflector 6 but enabling the unselective output of light emitted by the selectively controlled pixels of the pixellated light emitter 4.

In the reflective mode 14 pixels of the pixellated light emitter 4 are controlled not to emit light and the pixels of the pixellated polarizer 2 are controlled to selectively provide the defined polarization. Those pixels of the pixellated polarizer 2 that provide the defined polarization prevent the output of light reflected off the reflector 6 and appear black. Those pixels of the pixellated polarizer 2 that do not provide the defined polarization enable the output of light reflected off the reflector 6. The gray shades of the output light can be controlled by controlling the polarization of the pixellated polarizer 2 In the selective transflective mode 16 pixels of the pixellated light emitter 4 are selectively controlled to emit light and the pixels of the pixellated polarizer 2 are controlled to selectively provide a controlled polarization that controls the reflection of ambient light. Those pixels of the pixellated polarizer 2 that are controlled to provide a defined polarization prevent the output of ambient light reflected off the reflector 6. Those pixels of the pixellated polarizer 2 that are controlled to provide a different polarization enable the output of ambient light reflected off the reflector 6 and the output of light emitted by the selectively controlled pixels of the pixellated light emitter 4. Unpolarised light from the light emitter is transmitted through the stack regardless of the state of the pixellated polarizer.

FIG. 2B schematically illustrates a table that identifies the state of the pixellated light emitter 4 and the pixellated polarizer 2 in each of two sub-modes of the selective transflective mode 16.

In a ‘selective reflective with corresponding selective backlighting’ (SRCSB) sub-mode 16A, the pixellated light emitter 4 emits backlighting only in areas where the pixels of the pixellated polarizer 2 do not provide the defined polarization, thus saving power in the backlight and increasing contrast in low ambient light. In this high contrast mode, if the pixels of the pixellated polarizer 2 provide the defined polarization, the output is black (when there is no backlighting) or attenuated backlighting (when there is backlighting). If the pixels of the pixellated polarizer 2 do not provide the defined polarization, the output is the backlighting output of the pixellated light emitter 4.

If the dynamic range of the emissive luminance of an image is within a predetermined threshold value, the histogram representing the emissive luminance can be ‘shifted’ by representing the histogram using a maximum ‘steady-state’ base luminance from reflected light and a dynamic luminance from the pixellated light emitter. The luminance of the pixellated light emitter is then decreased accordingly to maintain the total image luminance, and power is thus saved.

In a ‘separated luminance and chrominance’ (SLC) sub-mode 16B of the selective transflective mode, the luminance of each image pixel is calculated and displayed using the pixellated polarizer 2 and reflected ambient light whereas the chrominance is converted to Red-Green-Blue (RGB) values and displayed using the pixellated light emitter 4. In this way, ambient light contributes to luminance whereas emitted light contributes to chrominance of the image, hence saving power and increasing the luminance resolution of the color image.

In this high color sub-mode, the pixels of the pixellated polarizer 2 are controlled to selectively provide a polarization. The gray shades of the reflected light can be controlled by controlling the polarization provided by a pixel of the pixellated polarizer 2. The pixels of the pixellated light emitter 4 are selectively controlled to emit different colored light. The selective control of the pixels of the pixellated polarizer 2 is independent of the selective control of the pixellated light emitter 4.

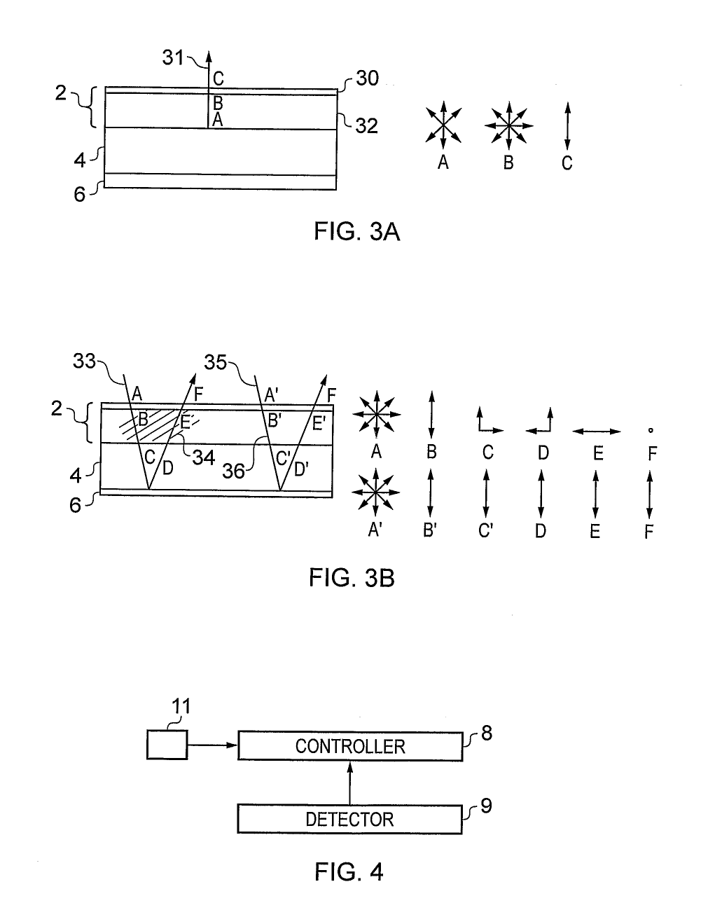

FIGS. 3A and 3B schematically illustrate one embodiment of the display apparatus 10 in which the pixellated polarizer 2 comprises a linear polarizer 30 in combination with a pixellated adaptively birefringent film 32 (switchable quarter-wave plate). The birefringent film 32 has a first array of pixels. Each pixel can independently have at least two states, monostable, bistable, or multistable, and can be either passively or actively (using transparent TFTs made from eg oxides) driven. Each pixel can be adaptively controlled to change state. In a first state, a pixel of the birefringent film operates as a ¼ wave plate and in combination with the linear polarizer 30 forms a circular polarizer. In a second state, a pixel of the birefringent film does not operate as a ¼ wave plate and in combination with the linear polarizer 30 does not form a circular polarizer. In this second state, the pixellated polarizer may for example operate as a linear polarizer.

The birefringent film 32 may be a pixellated liquid crystal layer. The liquid crystal layer 32 may be mono-stable, multi-stable, or bistable. For example, the liquid crystal layer may remain in the first state operating as a ¼ wave plate without drawing power and remain in the second state without drawing power. In the multi-stable case, all states are stable and do not draw any power. In the monostable case, all states except one (normal) draw power and active driving by TFTs would be beneficial.

The liquid crystal layer 32 may be a passive or active matrix liquid crystal arrangement.

In some embodiments, the liquid crystal layer may be a surface-stabilized ferroelectric liquid crystal or other liquid crystals modes with surface stabilization, e.g. zenithal bistable or bistable nematic display.

FIG. 3A schematically illustrates the operation of the pixellated light emitter 4 when emitting light 31. Irrespective of the state of the pixellated polarizer 2, unpolarized light (A) emitted from the pixellated light emitter 4, is linearly polarized by the linear polarizer 30 to form polarized light (C).

Therefore in the transmissive mode 12, the light generated selectively by the pixellated light emitter 4 is output by the display apparatus 10 (with some attenuation).

Therefore in the selective transflective mode 16, the light generated selectively by the pixellated light emitter 4 is output by the display apparatus 10 (with some attenuation).

FIG. 3B schematically illustrates the operation of the display apparatus 10 with respect to reflected light 33, 35. In this figure, a pixel 34 of the birefringent film 32 is in a first state and operates as a ¼ wave plate. In this region, the pixel 34 of the pixellated polarizer circularly polarizes the light. In this figure, a pixel 36 of the birefringent film 32 is in a second state and does not operate as a ¼ wave plate. In this region, the pixel 36 of the pixellated polarizer does not circularly polarize the light.

The light path 33 passes through the linear polarizer 30, the pixel 34 of the birefringent film 32, the pixellated light emitter 4 to the reflector 6 where it is reflected back through the pixellated light emitter 4, the pixel 34 of the birefringent film 32 to the linear polarizer 30. In other embodiments, the reflector 6 may additionally or alternatively be on top of the pixellated light emitter 4. The polarization vectors of the light along this path are illustrated using references A-F. The light is initially unpolarized (A). It is linearly polarized (B) after passing through the linear polarizer 30. It is circularly polarized (C) after passing through the pixel 34 of the birefringent film 32. After reflection by reflector 6, the light remains circularly polarized but with an opposite handedness (D). It is linearly polarized (E) after passing through the pixel 34 of the birefringent film 32, although the vector of polarization is now orthogonal to that of the linear polarizer. Consequently, the light 33 does not pass through the linear polarizer 30. This results in the pixel 34 appearing black.

In the transmissive mode 12, reflected light is absorbed by the linear polarizer 30 across the whole of the first array of pixels as all the pixels of the pixellated polarizer 2 are in the first state and provide circular polarization.

In the reflective mode 14, reflected light is absorbed by the linear polarizer 30 at those pixels of the first array that are in the first state and consequently provide circular polarization. Selectively controlling which of the first array of pixels of the pixellated polarizer 2 are in the first state therefore controls which pixels of the display apparatus 10 are ‘off’.

In the high contrast transflective mode 16A, reflected light is absorbed by the linear polarizer 30 at those pixels of the first array that are in the first state and consequently provide circular polarization. Selectively controlling which of the first array of pixels of the pixellated polarizer 2 are in the first state therefore controls which pixels of the display apparatus 10 are ‘off’.

The light path 35 passes through the linear polarizer 30, the pixel 36 of the birefringent film 32, the pixellated light emitter 4 to the reflector 6 where it is reflected back through the pixellated light emitter 4, the pixel 36 of the birefringent film 32 to the liner polarizer 30. The polarization vectors of the light along this path are illustrated using references A′-F′. The light is initially unpolarized (A). It is linearly polarized (B) after passing through the linear polarizer 30. It is still linearly polarized (C) after passing through the pixel 36 of the birefringent film 32. After reflection by reflector 6, the light remains linearly polarized (D). It is still linearly polarized (E) after passing through the pixel 34 of the birefringent film 32, and its vector of polarization is parallel to that of the linear polarizer 30. Consequently, the light 35 passes through the linear polarizer 30. This results in the pixel 36 appearing white.

In the transmissive mode 12, there are no pixels in the second state. Consequently, no reflected light passes back-out through the linear polarizer 30.

In the reflective mode 14, reflected light is emitted by the linear polarizer 30 at those pixels of the first array that are in the second state and consequently do not provide circular polarization. Selectively controlling which of the first array of pixels of the pixellated polarizer 2 are in the second state therefore controls which pixels of the display apparatus 10 are ‘on’.

In the high contrast transflective mode 16A, reflected light is emitted by the linear polarizer 30 at those pixels of the first array that are in the second state and consequently do not provide circular polarization. Selectively controlling which of the first array of pixels of the pixellated polarizer 2 are in the second state therefore controls which pixels of the display apparatus 10 are ‘on’.

In the transmissive mode 12, pixels of the pixellated light emitter 4 are selectively controlled to emit light. The pixels of the pixellated polarizer 2 are unselectively controlled to have the first state and consequently provide circular polarization. The large scale circular polarization prevents the output of light reflected off the reflector 6 by the display apparatus 10 but enables the unselective output of light emitted by the selectively controlled pixels of the pixellated light emitter 4.

In the reflective mode 14 pixels of the pixellated light emitter 4 are controlled not to emit light and the pixels of the pixellated polarizer 2 are controlled to selectively have the first state and consequently provide circular polarization. Those pixels of the pixellated polarizer 2 that are in the first state and provide circular polarization prevent the output of light reflected off the reflector 6. Those pixels of the pixellated polarizer 2 that are in the second state and do not provide circular polarization enable the output of light reflected off the reflector 6.

In the high contrast selective transflective mode 16A pixels of the pixellated light emitter 4 are selectively controlled to emit light and the pixels of the pixellated polarizer 2 are controlled to selectively have a first state and consequently provide circular polarization. Those pixels of the pixellated polarizer 2 that are in a first state and provide a circular polarization prevent the output of light reflected off the reflector 6. Those pixels of the pixellated polarizer 2 that are in a second state and do not provide circular polarization enable the output of light reflected off the reflector 6. The pixellated polarizer 2 additionally unselectively enables the output of light emitted by the selectively controlled pixels of the pixellated light emitter 4.

FIG. 4 schematically illustrates another embodiment of the controller 8. In this embodiment, the controller 8 receives input from a detector 9 and/or from a user input 11.

In one implementation the detector 9 is one or more ambient light detectors. In the selective transflective mode 16, the controller 8 is configured to selectively control pixels of the pixellated light emitter 4 to emit light in dependence upon the detected light.

In the high contrast SRCSB sub-mode 16A of the selective transflective mode 16. a monochrome backlighting color may be selected to improve contrast.

In the high color SLC sub-mode 16B of the selective transflective mode 16, the control of the pixellated light emitter may depend upon the color of the detected ambient light. For example, the ratio of RGB pixels in the pixellated light emitter may be determined using an algorithm that models the adaptation state of the eye and the color of the ambient light.

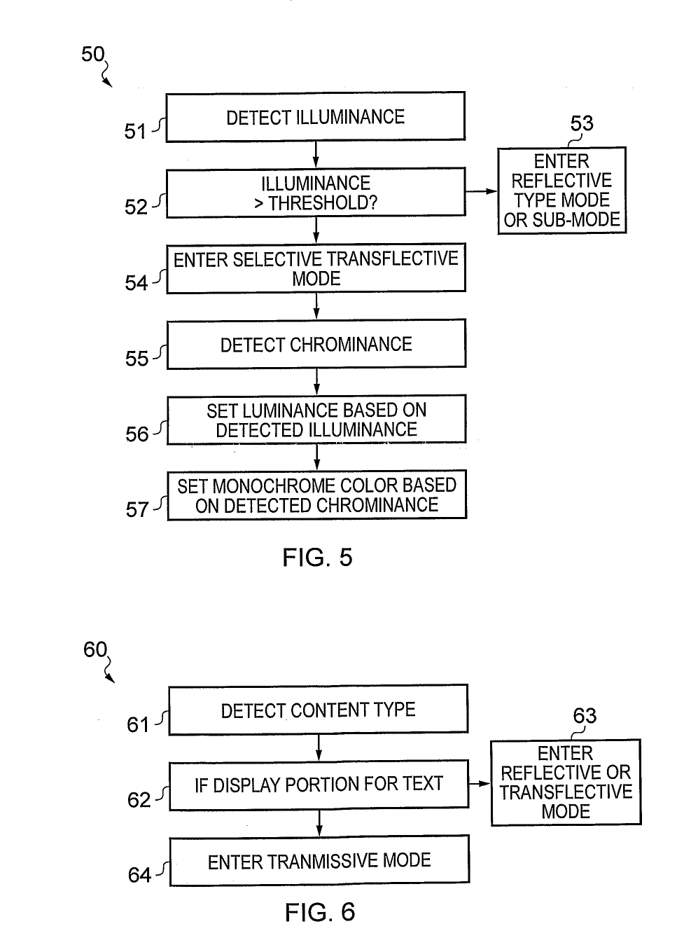

FIG. 5 schematically illustrates a suitable method 50 for performance by the controller 8.

At block 51, the controller 8 receives data from the detector characterizing detected ambient light (e.g. illuminance, chrominance).

At block 52, the controller 8 determines whether or not an intensity of the detected light (illuminance) exceeds a defined threshold. If the threshold is exceeded, there is sufficient ambient light for operation of a reflective type mode or sub-mode such as the reflective mode 14 or the high color SLC sub-mode 16B of the selective transflective mode 16. At block 53 the controller enters the reflective-type mode or sub-mode. If the threshold is not exceeded, there is insufficient ambient light for operation of a reflective type mode or sub-mode and the controller, at block 54, enters the high contrast SRCSB sub-mode 16A of the selective transflective mode 16.

In the selective transflective mode 16, at block 55, the controller 8 optionally determines a color of the ambient light (chrominance).

At block 56, the controller 8 selectively controls pixels of the pixellated light emitter 4 to emit light with an intensity (luminance) dependent upon an intensity of the detected ambient light (illuminance) and any user or system preferences such as ambient luminance contrast. Typically the pixellated light emitter 4 emits light of a uniform monochrome color at those pixels that are selectively controlled to emit light.

Optionally at block 57, the controller 8 selectively control pixels of the pixellated light emitter 4 to emit light with a color dependent upon a user or system setting or dependent upon the color of the detected ambient light. For example, the pixellated light emitter 4 may emit light with a color that has good contrast properties in the ambient light. As an example, if the color of the ambient light indicates tungsten filament lighting the pixellated light emitter 4 may selectively emit monochrome blue light.

FIG. 6 schematically illustrates a suitable method 60 for performance by the controller 8.

At block 61, the controller 8 receives data defining content for display by the display apparatus 10. The controller 8 analyses the content for type and its relative location in the display. The controller identifies those parts of the first/second array that are used for text data. The controller identifies those parts of the first/second array that are used for colored images.

At block 62, if the controller 8 determines that content for a first part of the first/second array is text data, the controller 8, at block 64, enters the selective transflective mode 16 or the reflective mode 14 for that content at the first part of the first/second array. The choice between the selective transflective mode 16 and the reflective mode 14 and the sub-modes of the transflective mode may, for example, be made according to method 50 in FIG. 5.

At block 62, if the controller 8 determines that content for a second part of the first/second array is colored image data or nor text data, the controller 8 enters the transmissive mode 12 for that content at the second part of the first/second array.

The controller 8 is thus configured to simultaneously display the first text content and the second image content by controlling the pixellated polarizer 2 and pixellated light emitter 4 to adopt the transmissive mode 12 for the second image content and simultaneously to adopt the reflective mode 14 or selective transflective mode for the first text content.

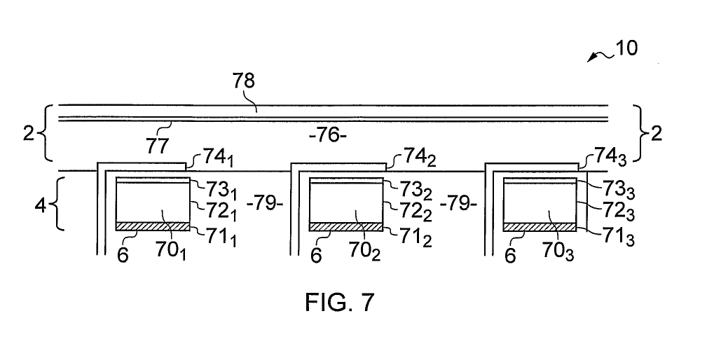

FIG. 7 schematically illustrates one implantation of the display apparatus 10. In this implementation, the pixellated light emitter 4 is formed from a second array of organic light emitting diodes (OLED) 70ₙ. An OLED 70ₙ comprises an upper transparent electrode 73ₙ which may, for example, be formed from indium tin oxide, a lower metallic electrode 71ₙ and organic light emitting material 72ₙ positioned between the electrodes. The lower metallic electrodes 71ₙ of the second array of OLEDs 70ₙ form the reflector 6. The OLEDs 70ₙ are encapsulated in transparent insulator 70.

The pixellated polarizer 2 is formed from a first array of transparent pixel electrodes 74ₙ, a liquid crystal layer 76, an upper common transparent electrode layer 77 and a linear polarizer 78.

The first array of transparent pixel electrodes 74ₙ for the pixellated polarizer 2 and the second array of OLEDs 71 ₙ are in register. For example, each OLEDs 71ₙ overlies a transparent pixel electrodes 74ₙ or each transparent pixel electrodes 74ₙ underlies an OLEDs 71ₙ.

In the selective transflective mode 16, the pixels of the pixellated light emitter 4 that are selected for light transmission are in register with the pixels of the pixellated polarizer 2 that are selected for emission of reflected light. The pixels of the pixellated light emitter 4 that are selected for no light transmission are in register with the pixels of the pixellated polarizer 2 that are selected for preventing emission of reflected light.

In some implementations, the first array may have a greater density than the second array. If the pitch or separation between the OLEDs 71ₙ is p1 and the pitch or separation between the transparent pixel electrodes 74ₙ is p2, then p1 may equal N*p2, where N is a natural number greater than or equal to 2.

In some implementations, the first array may have a smaller density than the second array. If the pitch or separation between the OLEDs 71ₙ is p1 and the pitch or separation between the transparent pixel electrodes 74ₙ is p2, then p1 may equal 1/M*p2, where M is a natural number greater than or equal to 2.

In some implementations, the pixellated polarizer 2 may comprise multiple different segments of any shape and number.

Although the Figure illustrates a top emission type OLED, in which the upper electrode is transparent, in other embodiments the OLED can be a bottom emission type where there is high reflectance from underlying metal layers.

Implementation of the controller 8 can be in hardware alone (a circuit, a processor . . . ), have certain aspects in software including firmware alone or can be a combination of hardware and software (including firmware).

The controller may be implemented using instructions that enable hardware functionality, for example, by using executable computer program instructions in a general-purpose or special-purpose processor that may be stored on a computer readable storage medium (disk, memory etc) to be executed by such a processor.

The display apparatus 10 may be a module for an electronic device. As used here ‘module’ refers to a unit or apparatus that excludes certain parts/components that would be added by an end manufacturer or a user.

The blocks illustrated in the FIGS. 5 and 6 may represent steps in a method and/or sections of code in the computer program. The illustration of a particular order to the blocks does not necessarily imply that there is a required or preferred order for the blocks and the order and arrangement of the block may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An apparatus comprising:
a pixellated polarizer comprising a first array of pixels wherein each pixel can be selectively controlled either to provide a defined polarization or not to provide a defined polarization;
a pixellated light emitter comprising a second array of pixels wherein each pixel can be selectively controlled to emit light;
a reflector; and
a controller configured to control the pixellated polarizer and pixellated light emitter to adopt in a first context a transmissive mode, in a second context a reflective mode and in a third context a selective transflective mode,
wherein
in the transmissive mode, pixels of the pixellated light emitter are selectively controlled to emit light and the pixels of the pixellated polarizer are unselectively controlled to provide the defined polarization;
in the reflective mode pixels of the pixellated light emitter are controlled not to emit light and the pixels of the pixellated polarizer are controlled to selectively provide the defined polarization;
in the selective transflective mode pixels of the pixellated light emitter are selectively controlled to emit light and the pixels of the pixellated polarizer are controlled to selectively provide a controlled polarization

2. An apparatus as claimed in claim 1, wherein
in the transmissive mode, pixels of the pixellated light emitter are selectively controlled to emit light and the pixels of the pixellated polarizer are unselectively controlled to provide the defined polarization preventing the output of light reflected off the reflector but enabling the unselective output of light emitted by the selectively controlled pixels of the pixellated light emitter;
in the reflective mode pixels of the pixellated light emitter are controlled not to emit light and the pixels of the pixellated polarizer are controlled to selectively provide the defined polarization wherein those pixels of the pixellated polarizer that provide the defined polarization prevent the output of light reflected off the reflector and those pixels of the pixellated polarizer that do not provide the defined polarization enable the output of light reflected off the reflector.

3. An apparatus as claimed in claim 1, wherein
in a high contrast selective transflective mode pixels of the pixellated light emitter are selectively controlled to emit light and the pixels of the pixellated polarizer are controlled to selectively provide a defined polarization wherein those pixels of the pixellated polarizer that provide a defined polarization prevent the output of light reflected off the reflector and those pixels of the pixellated polarizer that do not provide a defined polarization enable the output of light reflected off the reflector and the pixellated polarizer enables the output of light emitted by the selectively controlled pixels of the pixellated light emitter.

4. An apparatus as claimed in claim 3, wherein the pixels of the pixellated light emitter that are selectively controlled to emit light spatially correspond to the pixels of the pixellated polarizer that do not provide a defined polarization.

5. An apparatus as claimed in claim 3, wherein in the high contrast selective transflective mode the controller is configured to selectively control pixels of the pixellated light emitter to emit light of a uniform monochrome color.

6. An apparatus as claimed in claim 1, wherein
in a high chrominance selective transflective mode pixels of the pixellated light emitter are selectively controlled to emit colored light and the pixels of the pixellated polarizer are controlled to selectively provide luminance control by controlling polarization.

7. An apparatus as claimed in claim 1, wherein the defined polarization is circular polarization.

8. An apparatus as claimed in claim 1, further comprising an ambient light detector, wherein a transition from the second context to the first context occurs as the detected ambient light reduces.

9. An apparatus as claimed in claim 1, further comprising an ambient light detector, wherein in the selective transflective mode the controller is configured to selectively control pixels of the pixellated light emitter to emit light in dependence upon the detected light.

10. An apparatus as claimed in claim 9, wherein the controller is configured to selectively control pixels of the pixellated light emitter to emit light with an intensity dependent upon an intensity of the detected light.

11. An apparatus as claimed in claim 9, wherein the controller is configured to selectively control pixels of the pixellated light emitter to emit light with a color dependent upon a color of the detected light.

12. An apparatus as claimed in claim 1, wherein the context is dependent upon content for display, wherein the controller is configured to simultaneously display first content and second content by controlling the pixellated polarizer and pixellated light emitter to adopt the transmissive mode for the first content and simultaneously to adopt the reflective mode for the second content.

13. (canceled)

14. An apparatus as claimed in claim 1, wherein the context is dependent upon content for display, wherein the controller is configured to simultaneously display first content and second content by controlling the pixellated polarizer and pixellated light emitter to adopt the transmissive mode for the first content and simultaneously to adopt the selective transflective mode for the second content.

15. (canceled)

16. (canceled)

17. An apparatus as claimed in claim 1, wherein the reflector is provided by electrodes of the pixellated light emitter.

18. An apparatus as claimed in claim 1, wherein the pixellated light emitter comprises a second array of organic light emitting diodes.

19. (canceled)

20. (canceled)

21. (canceled)

22. (canceled)

23. (canceled)

24. (canceled)

25. (canceled)

26. Method comprising:
determining whether to control a pixellated polarizer and a pixellated light emitter to adopt a transmissive mode, a reflective mode or a selective transflective mode;
in a first context entering the transmissive mode and selectively controlling pixels of the pixellated light emitter to emit light and unselectively controlling pixels of the pixellated polarizer to provide a defined polarization;
in a second context entering the reflective mode and controlling pixels of the pixellated light emitter not to emit light and controlling the pixels of the pixellated polarizer to selectively provide the defined polarization;
in a third context entering the selective transflective mode and selectively controlling pixels of the pixellated light emitter to emit light and controlling the pixels of the pixellated polarizer to selectively provide a defined polarization.

27. A method as claimed in claim 26, further comprising, in the selective transflective mode, selectively controlling pixels of the pixellated light emitter to emit light in dependence upon detected ambient light.

28. A method as claimed in claim 26, further comprising, in a high contrast selective transflective mode selectively controlling pixels of the pixellated light emitter to emit light of a uniform monochrome color.

29. A method as claimed in claim 26, further comprising simultaneously displaying first and second content by controlling the pixellated polarizer and pixellated light emitter to adopt the transmissive mode for the first content and simultaneously to adopt the selective transflective mode for the second content.

30. A module for an apparatus comprising:
a pixellated polarizer comprising a first array of pixels wherein each pixel can be selectively controlled either to provide a defined polarization or not to provide a defined polarization;
a pixellated light emitter comprising a second array of pixels wherein each pixel can be selectively controlled to emit light;
a reflector; and
a controller configured to control the pixellated polarizer and pixellated light emitter to adopt in a first context a transmissive mode, in a second context a reflective mode and in a third context a selective transflective mode,
wherein
in the transmissive mode, pixels of the pixellated light emitter are selectively controlled to emit light and the pixels of the pixellated polarizer are unselectively controlled to provide the defined polarization;
in the reflective mode pixels of the pixellated light emitter are controlled not to emit light and the pixels of the pixellated polarizer are controlled to selectively provide the defined polarization;
in the selective transflective mode pixels of the pixellated light emitter are selectively controlled to emit light and the pixels of the pixellated polarizer are controlled to selectively provide a defined polarization.
